(19) United States
(12) Patent Application Publication
(10) Pub. No.: US 2007/0271344 A1
(43) Pub. Date: Nov. 22, 2007

(54) Electronic mail message document attachment

(76) Inventors: Kannan Danasekaran, San Diego, CA (US); Steven Ross Iverson, San Diego, CA (US)

Correspondence Address: FISH & RICHARDSON, PC, P.O. BOX 1022, MINNEAPOLIS, MN, 55440-1022, US

(21) Appl. No.: 11/439,487

(22) Filed: May 22, 2006

(51) Int. Cl. G06F 15/16

(52) U.S. Cl. 709/206

(57) ABSTRACT

A system can include: an online storage system; and a computer-readable medium having encoded thereon a computer program structured to interact with an electronic mail system and to provide a file-attachment interface that uploads a document to the online storage system in a separate process, and adds associated link information to an electronic mail message before completion of the separate process, in response to requested attachment of the document to the electronic mail message. A method can include: receiving information designating an electronic mail message currently being generated for an electronic mail system residing in a first domain; inserting, in response to the receiving, a file-attachment interface element into a user interface for the electronic mail message; and adding, in response to use of the file-attachment interface element, to the electronic mail message link information identifying a document stored in an online storage system residing in a second domain.

### BACKGROUND

The present disclosure relates to electronic mail (email) systems and online storage systems.

A computer network is a collection of computing nodes coupled together with wired and/or wireless communication links, such as coax cable, fiber optics and radio frequency bands. A computer network may be a single network or a collection of independent networks (i.e., an internetwork), and may use multiple networking protocols, including internetworking protocols. The Internet and Internet Protocol (IP) are a common example of an internetwork and internetworking protocol.

The Internet is a publicly accessible internetwork that has grown tremendously in recent years and provides an online home for the computing systems of many people and organizations. Part of the growth of the Internet has been fueled by the adoption of various markup languages, such as Hypertext Markup Language (HTML), which have facilitated the development of the World Wide Web (Web), which is a collection interlinked Web pages that provide a user interface to the information and resources of the Internet. Furthermore, the use of many additional computing technologies with the Web (e.g., Common Gateway Interface (CGI), Active Server Pages (ASP), and Dynamic HTML, to name just a few) have enabled businesses to readily provide Web based services to people throughout the world.

### SUMMARY

The present disclosure includes systems and techniques relating to electronic mail message document attachment. According to an aspect, a method can include: receiving information designating an electronic mail message currently being generated for an electronic mail system residing in a first domain of a computer internetwork; inserting, in response to the receiving, a file-attachment interface element into a user interface for the electronic mail message; and adding, in response to use of the file-attachment interface element, to the electronic mail message link information identifying a document stored in an online storage system residing in a second domain of the computer internetwork. The receiving can involve receiving, in a Web browser plug-in, markup language information defining the electronic mail message currently being generated for the electronic mail system including a Web based electronic mail system, and the inserting can involve inserting into the markup language information the file-attachment interface element in accordance with a link format of the Web based electronic mail system. Moreover, the inserting can involve inserting two file-attachment interface elements, a first of the file-attachment interface elements for attaching documents already stored at the online storage system, and a second of the file-attachment interface elements for attaching local documents via upload to the online storage system rather than to the electronic mail system.

The adding can involve presenting, in response to selection of the file-attachment interface element, a user interface for document selection; initiating, in response to selection of one or more documents, document upload from local storage to the online storage system as a background process; obtaining the link information before the document upload completes; and inserting the link information into the electronic mail message. The method can also include sending access control information for the one or more documents to the online storage system, and the obtaining the link information can involve obtaining a link to an attachment package at the online storage system having the access control information associated with the attachment package. In addition, the obtaining the link information can involve obtaining multiple links to an attachment package at the online storage system, and the inserting the link information can involve inserting a unique link to the attachment package for each of a plurality of designated recipients of the electronic mail message.

According to another aspect, a system can include an online storage system; and a computer-readable medium having encoded thereon a computer program structured to interact with an electronic mail system and to provide a file-attachment interface that uploads a document to the online storage system in a separate process, and adds associated link information to an electronic mail message before completion of the separate process, in response to requested attachment of the document to the electronic mail message. The online storage system can reside in a first domain of a computer internetwork, the electronic mail system can reside in a second domain of the computer internetwork, and the computer program can reside in a third domain of the computer internetwork. The electronic mail system can include a Web based electronic mail system, and the computer program can include a Web browser plug-in structured to insert a file-attachment interface element into a Web page in accordance with a link format of the Web based electronic mail system.

The file-attachment interface can include a first file-attachment interface element for attaching documents already stored at the online storage system, and a second file-attachment interface element for attaching local documents via upload to the online storage system. The online storage system can be structured to provide the link information to the computer program before completion of the separate process. The separate process can include an upload application for the online storage system. The online storage system can include an access control component structured to restrict access to the document based on user provided access control information. The online storage system can be structured to provide the link information including multiple links to the document, the multiple links including a unique link to the document for each of a plurality of designated recipients of the electronic mail message.

The described systems and techniques can be implemented in electronic circuitry, computer hardware, firmware, software, or in combinations of them, such as the structural means disclosed in this specification and structural equivalents thereof. Thus, program implementations can be realized from a disclosed method, system, or apparatus, and apparatus implementations can be realized from a disclosed system, program, or method. Similarly, method implementations can be realized from a disclosed system, program, or apparatus, and system implementations can be realized from a disclosed method, program, or apparatus.

Particular embodiments of the invention can be implemented to realize one or more of the following advantages. Electronic mail systems can be enhanced by enabling users to readily attach and send documents with large amounts of data to email messages, without modifying an existing email protocol. Web based electronic mail systems can be enhanced using the systems and techniques described, and documents can be attached to email messages irrespective of any attachment size or attachment count limits imposed by either sending or receiving electronic mail systems. The systems and techniques described can be used with multiple different Web email providers, such as YAHOO!® Mail, Gmail™ Service, Hotmail® Service, etc.

A user can pick attachments to an email message from locations other than local drives. Both previously uploaded and yet to be uploaded documents can be readily attached to an email message and sent quickly. Yet to be uploaded documents can be attached, and the email message sent, in less time than it takes to upload the documents. Previously uploaded documents can be attached to new email messages without requiring additional time consuming uploads. Moreover, previously uploaded documents can be attached to an email message from any networked computing node, worldwide, that has Web browsing capability.

Since the attachment can be effected by link information and associated access restriction controls, the attached document can be secure from access by the email transporter as well as the sending party's and the receiving party's email service providers. Viewing and forwarding of the attachments can be tracked independent of the email service provider. Moreover, the original sender of the email can be provided with details of which recipient downloaded which attachment at what time. The attachments can be protected as needed by additional restrictions, which can be selected by the sender, including limiting access based on specific network address(es), domain(s), date(s), time(s), and password(s).

The details of one or more embodiments of the invention are set forth in the accompanying drawings and the description below. Other features, aspects, and advantages of the invention will become apparent from the description, the drawings, and the claims.

### BRIEF DESCRIPTION OF THE DRAWINGS

FIG. 1 shows an example electronic mail message document attachment system.

FIG. 2 shows an example of a Web page of a Web based electronic mail system.

FIG. 3 shows the Web page from FIG. 2 with an example file-attachment interface element inserted.

FIG. 4 shows the Web page from FIG. 2 with two example file-attachment interface elements inserted.

FIG. 5 shows another example of a Web page of a Web based electronic mail system.

FIG. 6 shows the Web page from FIG. 5 with another two example file-attachment interface elements inserted.

FIG. 7 shows an example process of electronic mail message document attachment.

FIG. 8 shows an example process of background document upload.

FIG. 9 shows an example email message as seen by a recipient.

FIG. 10 shows an example upload progress report for a still uploading attachment.

FIG. 11 shows an example download report for the example email message of FIG. 9.

Like reference numbers and designations in the various drawings indicate like elements.

### DETAILED DESCRIPTION

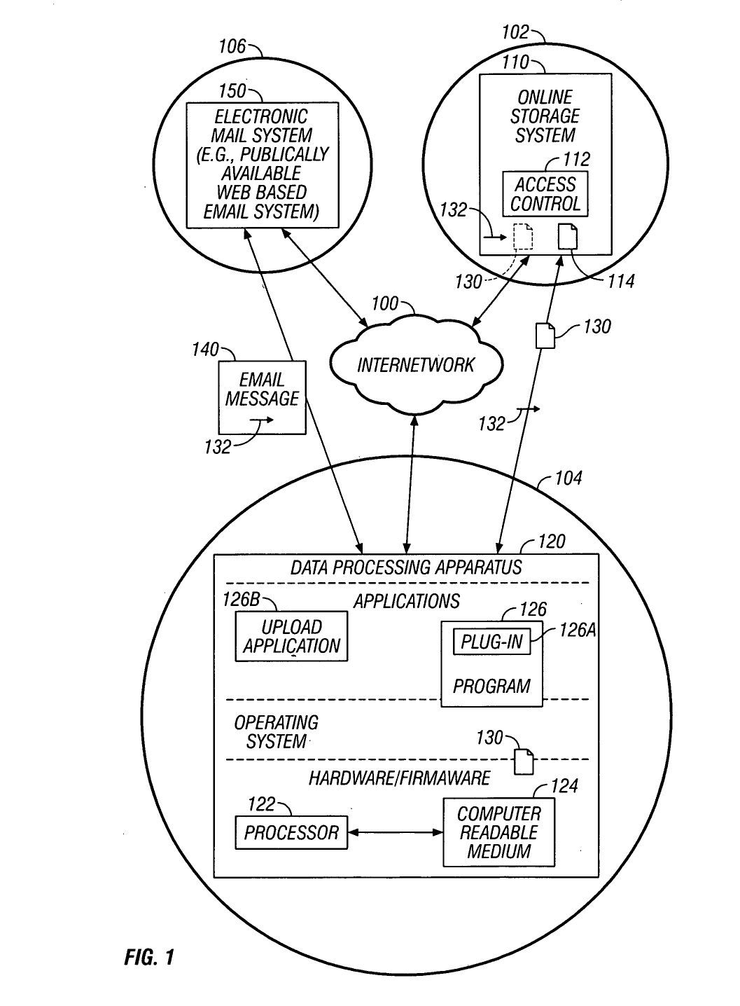

FIG. 1 shows an example electronic mail message document attachment system. An internetwork 100 (e.g., the Internet) provides communication connections between multiple domains. As used herein, the term “domain” refers to a group of computing nodes on a network that are administered together with common rules and procedures. Within the Internet, domains are defined by the IP address; all nodes sharing a common part of the IP address are said to be in the same domain.

An online storage system 110 resides in a first domain 102. The online storage system 110 provides a location to store documents, which can then be accessed from any node connected to the internetwork 100. The online storage system 110 can include multiple servers, server clusters, and substantial data storage capacity. The online storage system 110 can provide various mechanisms for uploading, accessing and sharing documents through the internetwork, including providing email functionality for registered users. For example, the online storage system 110 can be the STREAMLOAD® system provided by Streamload, Inc. of San Diego, Calif. The online storage system 110 can include an access control component 112 that governs accesses to stored documents (e.g., a document 114 that has been uploaded using a Web page interface provided by the system 110).

A data processing apparatus 120 resides in a second domain 104. The data processing apparatus 120 can be any computing node that can be connected to the internetwork 100, and need not have a fixed domain 104. For example, the apparatus 120 can be a laptop that connects to the internetwork 100 through wireless access points.

The data processing apparatus 120 can include hardware/firmware, an operating system, and one or more applications. The hardware/firmware can include a processor 122 (e.g., one or more semiconductor based microprocesors) and a computer-readable medium 124 interconnected (typically with other components) using one or more busses. The computer-readable medium 124 can be a fixed component of the apparatus 120 or be readily removable. The computer-readable medium 124 can have encoded thereon a computer program 126.that interacts with an electronic mail system 150 (e.g., a publicly available Web based email system) in a third domain 106. Through this interaction, electronic mail services can be provided to a user of the data processing apparatus 120.

The program 126 can interact with the electronic mail system 150 to construct an email message 140. In addition, the program 126 can provide a file-attachment interface that uploads a document 130 to the online storage system 110 in a separate process, and adds associated link information 132 (e.g., a Uniform Resource Locator (URL) address) to the email message 140 before completion of the separate process, in response to requested attachment of the document 130 to the email message 140. The separate process can be isolated in a separate execution context. Moreover, the separate process can be run as a background process, a foreground process, or a tiled window. Thus, the document 130 is attached to (connected as an associated part of) the email message 140 through the use of this link information 132, even though the actual data included in the document 130 is not itself included in the email message 140 or uploaded to the electronic mail system 150.

The link information 132 can be generated at the apparatus 120 or at the online storage system 110. For example, the program 126 can use predefined rules to generate the link information 132 before the online storage system 110 is contacted regarding the document upload. This link information 132 can then be provided to the online storage system 132 for use in identifying the document 130 from received requests, after the document 130 is uploaded. Alternatively, the program 126 can initiate the upload of the document 130, and before completion of this document upload, can receive the link information 132 from the online storage system 110. The link information 132 can then be included in the email message 140 even while the document upload proceeds. Thus, the email message 140 can be completed and sent to an intended recipient all before uploading of the document 130 to the online storage system 110 is finished.

The email message 140 can also include link information for a previously uploaded document 114. The access control component 112 can enforce authentication and authorization during the download of stored documents 114, 130 by the recipient of the email message 140. Moreover, if the recipient forwards the email message 140 to another, the attachments can remain included in the email message 140 as the link information 132. Subsequent access to the attachments can result in further downloads of the documents 114, 130 under the control of the access control component 112. Thus, the viewing and forwarding of the attachments can be tracked independent of the email service providers that handle the email message 140.

The computer program 126 can be implemented in various manners, including the use of multiple program modules, program threads, or combinations of them. For example, a separate program thread, or an entirely separate program application or service or daemon, can be used to effect the background upload of the document 130. The program 126 can include a plug-in component 126A and an upload application 126B that operate in separate execution contexts. For example, the upload application 126B can be a standalone application provided by the online storage system 110 for uploading of documents, and the plug-in component 126A can be a Web browser plug-in that communicates with the upload application 126B. The upload application 126B can use an Application Program Interface (API) provided by the online storage system 110 to communicate with the online storage system 110 (e.g., the STREAMLOAD® API available from Streamload, Inc. of San Diego, Calif.).

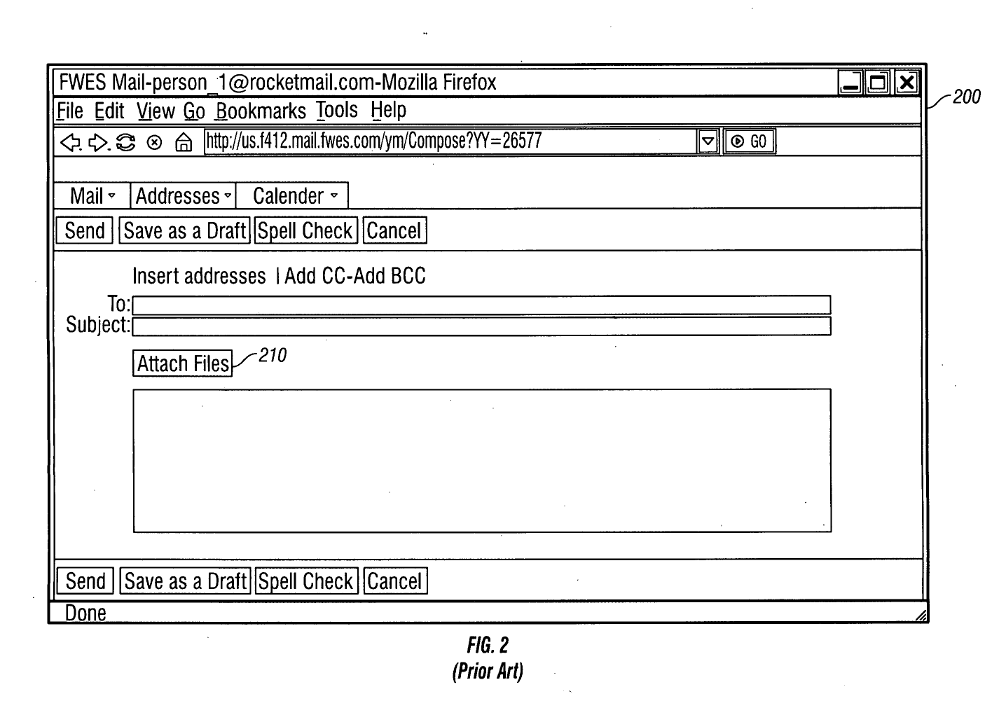

FIG. 2 shows an example of a Web page of a Web based electronic mail system. A Web browser window 200 shows a Web page used with a first Web email system (FWES, e.g., YAHOO!® Mail) to compose a new email message, as the page appears to the user on the screen. Included on the Web page is a button 210 used to open the document upload page, in which a user can select local files that are then fully uploaded to first domain (e.g., the YAHOO!® domain) before the user can return to composing the new email message. Note that in addition to Web server based systems, a Web based electronic mail system can include those created with software that facilitates delivery of interactive content, such as JAVA® plug-ins and FLASH® software (available from Adobe Systems Incorporated of San Jose, Calif.).

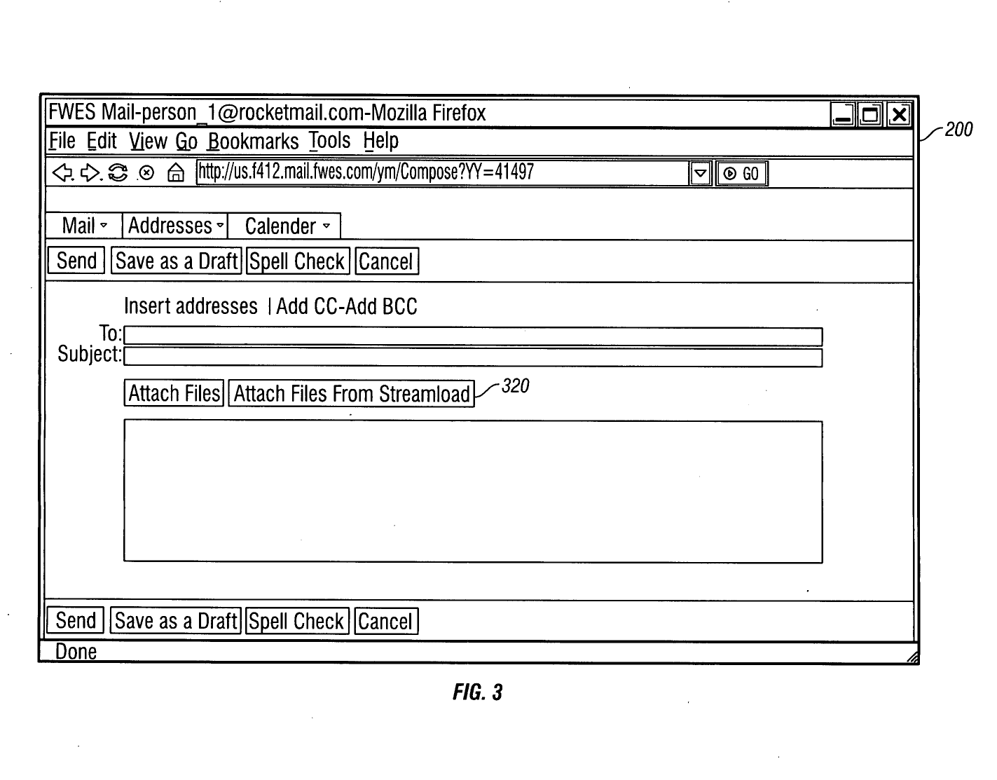

FIG. 3 shows the Web page from FIG. 2 with an example file-attachment interface element inserted. The Web browser window 200 now shows the Web page used with the first Web email system to compose a new email message, after a new button 320 has been included. For example, a Web browser plug-in on a user's personal computer can detect the access to YAHOO!® Mail (or another email service), and the button 320 can be injected into, the Web page. The button 320 forms part of a file-attachment interface in that clicking on the button 320 causes the opening of a user interface for attaching documents to the email message being composed. This user interface can allow attachment of previously uploaded documents or yet to be uploaded documents, such as described above, from an online storage system (e.g. the STREAMLOAD® system). This user interface can be a Web based interface, a graphical user interface of an upload application for the online storage system, or a combination of these.

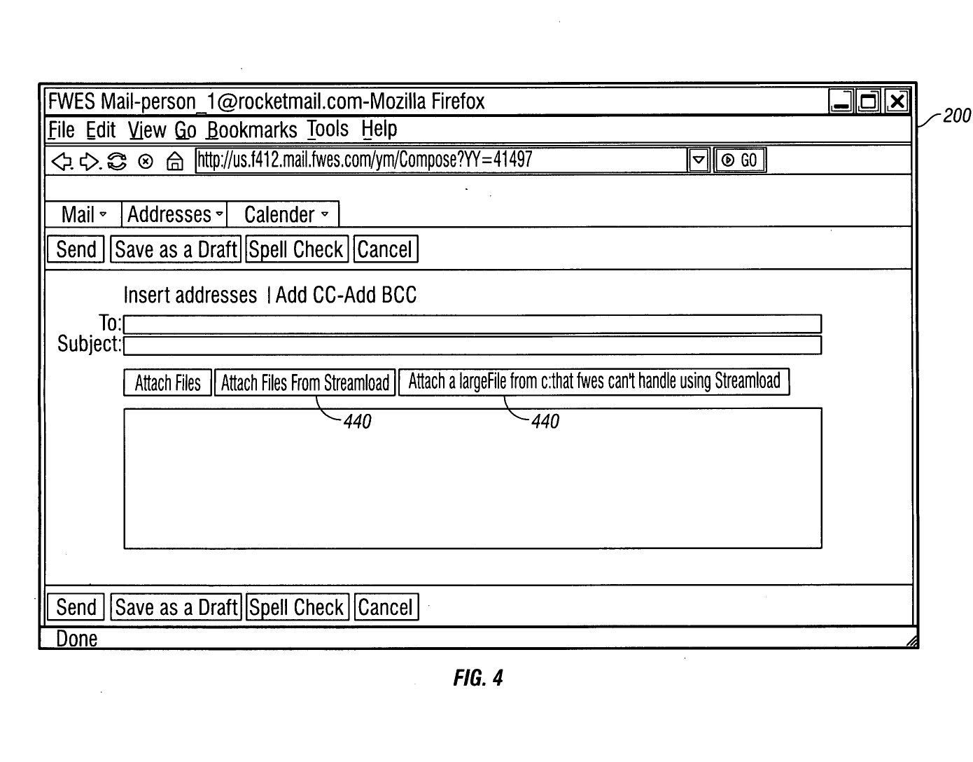

In addition, two separate file-attachment interface elements can be used instead of one. FIG. 4 shows the Web page from FIG. 2 with two example file-attachment interface elements inserted. A first button 430 can be used to attach previously uploaded documents, and a second button 440 can be used to attach yet to be uploaded documents. In any event, regardless of whether one or two file-attachment interface elements are inserted, when a user selects yet to be uploaded documents for attachment, the document upload can occur in a background process, separate from the interaction with the Web email service. Thus, the document upload can be initiated by attachment in an email message, but then proceed regardless of whether the email message is eventually sent or cancelled.

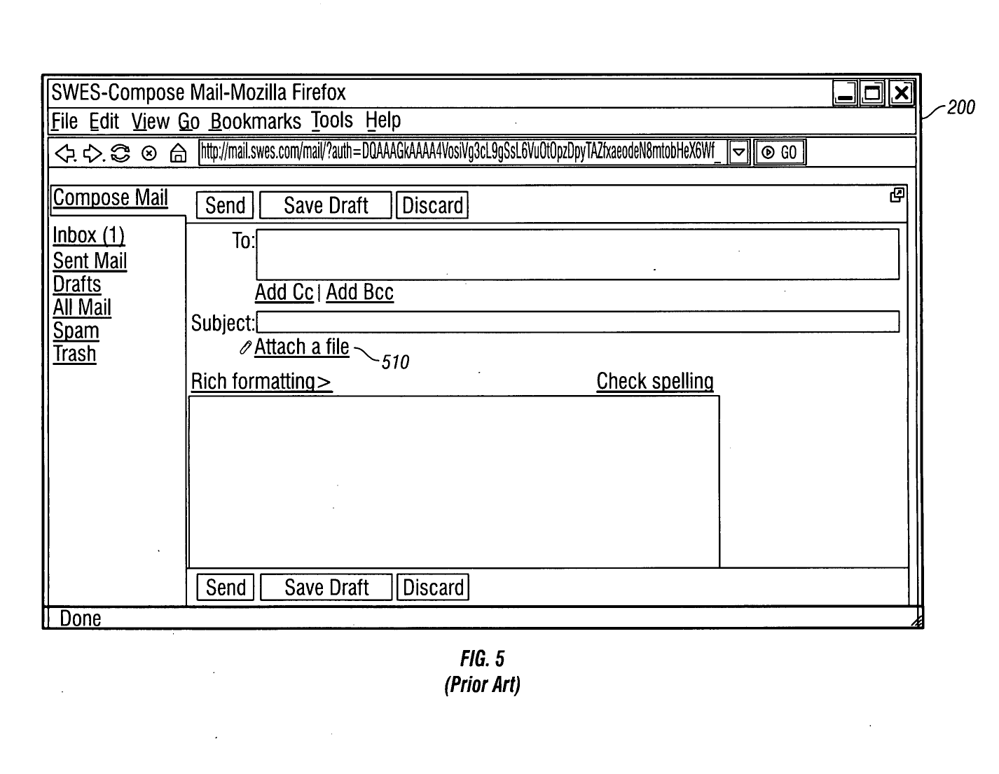

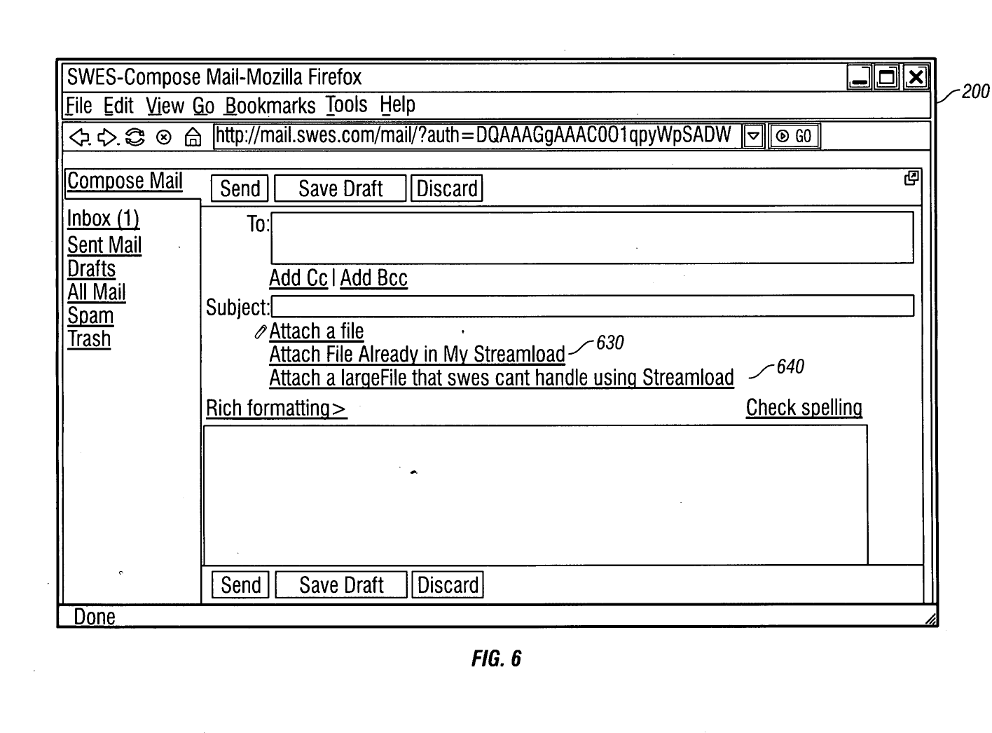

In addition, the file-attachment interface element(s) inserted can be prepared in accordance with a link format of the Web based electronic mail system. As shown in FIGS. 2-4, the file-attachment interface elements 320, 430, 440 are designed as buttons that appear similar to the button 210. FIG. 5 shows another example of a Web page of a Web based electronic mail system. The Web browser window 200 now shows a Web page used with a second Web email system (SWES, e.g., Gmail™ Service) to compose a new email message, as the page appears to the user on the screen. Included on the Web page is a text link 510 used to open the document upload page for the second Web email system. FIG. 6 shows the Web page from FIG. 5 with another two example file-attachment interface elements inserted. In this case, a first file-attachment interface element 630 and a second file-attachment interface element 640 are designed as links that appear similar to the text link 510.

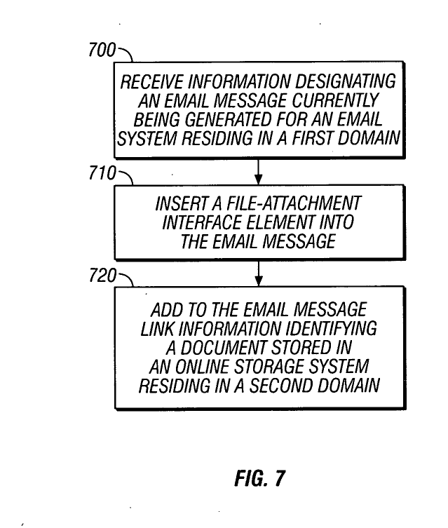

FIG. 7 shows an example process of electronic mail message document attachment. Information designating an electronic mail message currently being generated for an electronic mail system (residing in a first domain of a computer internetwork) can be received at 700. This can involve receiving, in a Web browser plug-in, markup language information (e.g., XHTML) defining the electronic mail message currently being generated for the electronic mail system.

In response to receipt of the information, a file-attachment interface element can be inserted into the electronic mail message at 710. This can involve inserting into the markup language information (e.g., into the body of the XHTML page presented to the user) the file-attachment interface element in accordance with a link format of a Web based electronic mail system. For example, an instance of a Web browser plug-in can reside in each browser window, and this plug-in can include a function that selects the link format (e.g., text or button) appropriate to a given domain being accessed. Moreover, the inserting can involve inserting more than one file-attachment interface element, such as described above.

In response to use of the file-attachment interface element, link information can be added to the electronic mail message at 720. The link information identifies a document stored (either currently or in the future) in an online storage system residing in a second domain of the computer internetwork. For example, the file-attachment interface element can be used to open anr interface for attaching local documents to the email message by uploading the local documents (in the background) to an online storage system.

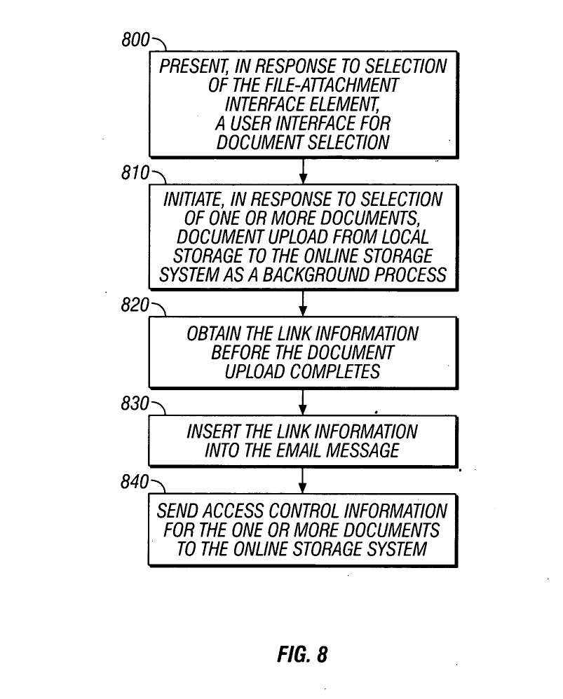

FIG. 8 shows an example process of background document upload. In response to selection of the file-attachment interface element, a user interface for document selection can be presented at 800. The user interface can be part of a separate document upload application triggered by selection of the file-attachment interface element. Moreover, the user interface can include options for specifying security features to control access to the documents. These security features can include options for specifying passwords, access domain restrictions (e.g., limit the IP addresses, or range of addresses, from which the document(s) can be accessed), the number of times the document(s) can be downloaded, and the times during which the document(s) can be downloaded (including potentially a final expiration date).

In response to selection of one or more documents using the user interface, document upload from local storage to the online storage system can be initiated as a background process at 810. This can involve first letting the online storage system know about the planned upload, so the online storage system can pre-create the link information to be used in the email message. For example, upon an initial communication with the online storage system, a message identifier (ID) can be received from the online storage system to identify the ongoing communication. This message ID can be used to create the link information to be added to the email message, and the online storage system can track the document upload and storage location(s) for uploaded document(s) based on this message ID.

The upload application can indicate that there are N documents to be uploaded, specify the document sizes, and then begin transmitting the documents. Once the document upload process is completed, the upload application can inform the server, and the server can change the status of the upload, from pending, to complete and ready for pickup. Thus, the document upload can occur separate from the email composition, and the email recipient can potentially receive the email message even before the document upload finishes.

The link information can be obtained at 820, before the document upload completes, and the link information can be inserted into the electronic mail message at 830. Obtaining the link information can involve obtaining multiple links to an attachment package at the online storage system. Inserting the link information can involve inserting a unique link to the attachment package for each designated recipient of the electronic mail message.

In addition, access control information for the document(s) can be sent to the online storage system at 840. This access control information can include various restrictions on access, such as described above. Moreover, this access control information can differentiate among specific email recipients, or groups of recipients.

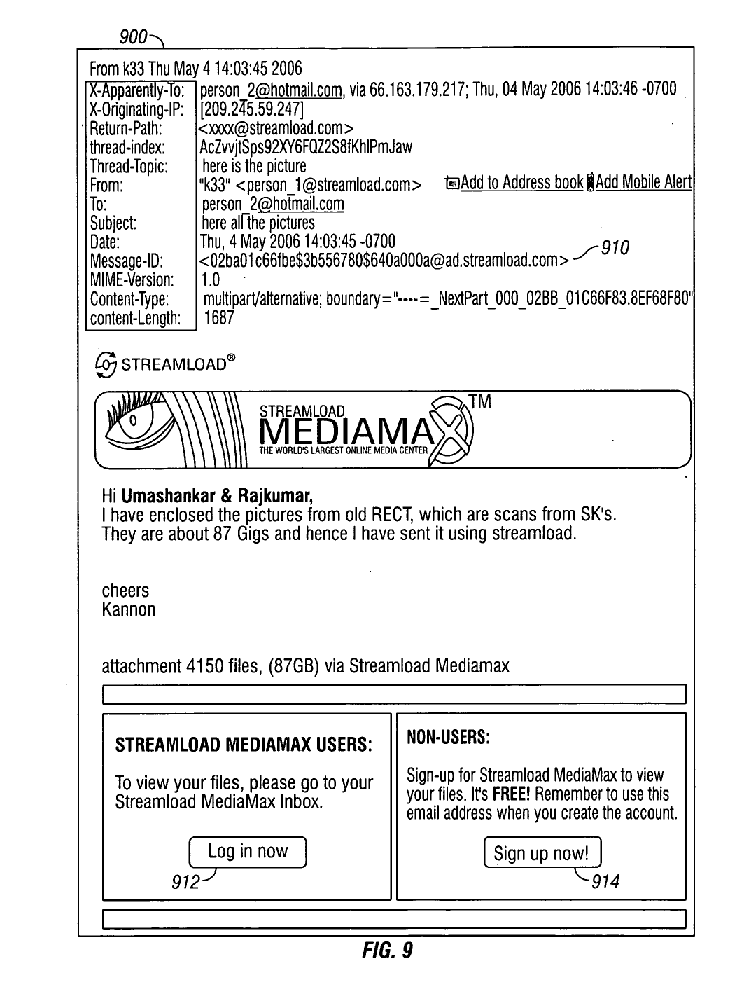

FIG. 9 shows an example email message 900 as seen by a recipient. The link information in this email message 900 includes a message ID 910 and two buttons 912 and 914. When the email recipient clicks on either of the buttons 912 and 914, the message ID 910 is sent to the online storage system along with the user request for access. Thus, the online storage system can identify the type of access, and the specific attachment sought, from the received request.

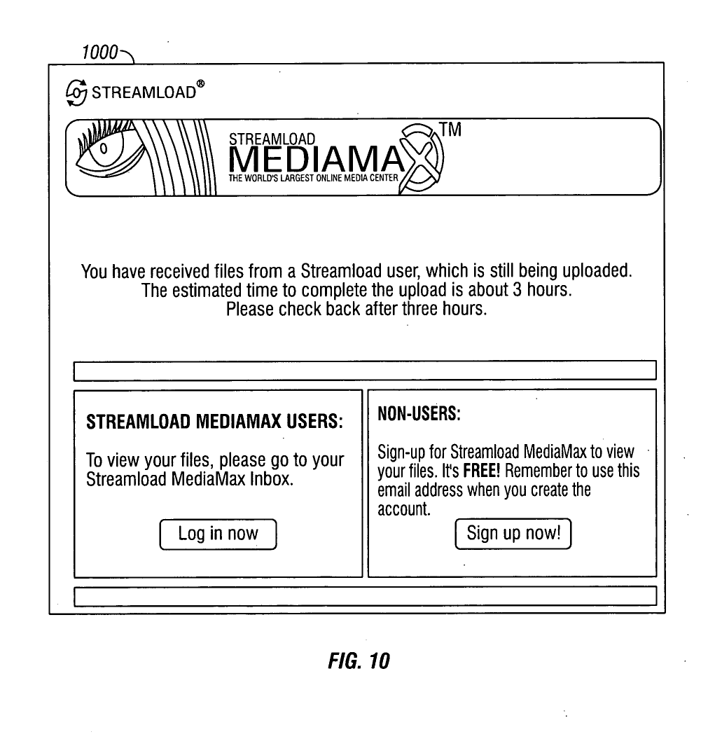

FIG. 10 shows an example upload progress report 1000 for a still uploading attachment. If the email recipient requests an attachment that is still being uploaded, the upload progress report 1000 can be provided (e.g., in a separate pop-up browser window) to explain why the sought attachment is still being uploaded. An estimate of the amount of time remaining (e.g., 3 hours) can also be provided, as shown.

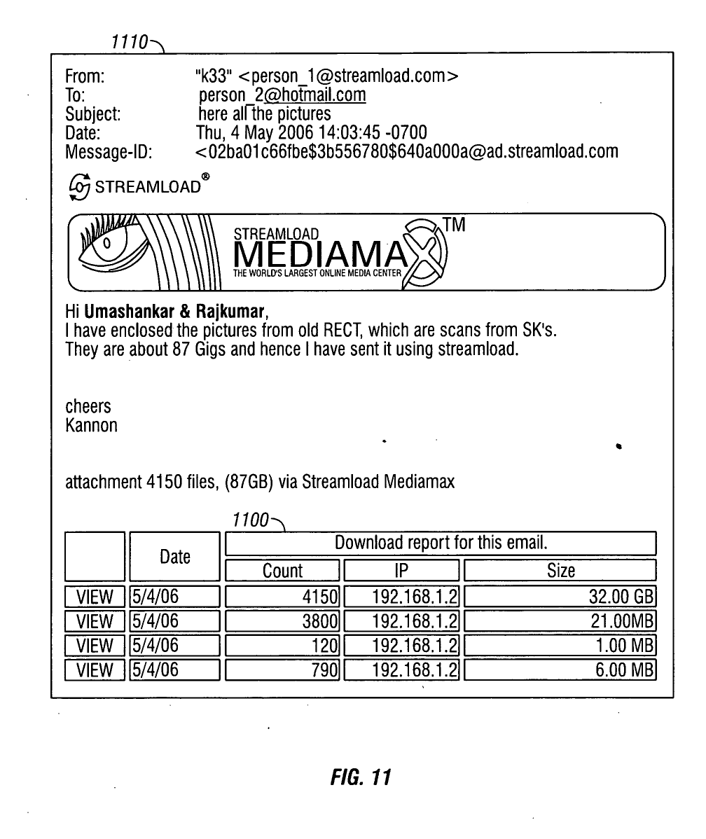

FIG. 11 shows an example download report 1100 for the example email message 900 of FIG. 9. The download report 100 can include information that tracks how the email attachment has been viewed, for example, when, how many of, from what IP address, and size of documents have been downloaded for viewing. In this case, the download report 1100 is included in a sent email message 1110 in the email senders email system. However, the download report 1100 can be included in other user interfaces, such as a general account user interface for the online storage system.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, i.e., one or more modules of computer program instructions encoded on a computer-readable medium for execution by, or to control the operation of, data processing apparatus. The computer-readable medium can be a machine-readable storage device, a machine-readable storage substrate, a memory device, or a combination of one or more of them, including a medium that receives a program from a machine-readable propagated signal. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims. For example, the actions recited in the claims can be performed in a different order and still achieve desirable results. Embodiments of the invention can include non-Web based embodiments, electronic mail system embodiments in which the described features are built into the system at design time rather than added on later, and embodiments in which the electronic mail system and the data processing apparatus reside in the same domain.

Moreover, inserting a file-attachment interface element into a user interface for an electronic mail message can be done in a variety of manners. For example, a browser toolbar can also be used to select document(s) from either the local drive or an online storage system. Once the document(s) have been selected, the link information for the selected item(s) can be inserted into the body of the message without modifying the email composer provided by the Web mail vendor.

What is claimed is:

1. A method comprising:
receiving information designating an electronic mail message currently being generated for an electronic mail system residing in a first domain of a computer internetwork;
inserting, in response to the receiving, a file-attachment interface element into a user interface for the electronic mail message; and
adding, in response to use of the file-attachment interface element, to the electronic mail message link information identifying a document stored in an online storage system residing in a second domain of the computer internetwork.

2. The method of claim 1, wherein the receiving comprises receiving, in a Web browser plug-in, markup language information defining the electronic mail message currently being generated for the electronic mail system comprising a Web based electronic mail system, and the inserting comprises inserting into the markup language information the file-attachment interface element in accordance with a link format of the Web based electronic mail system.

3. The method of claim 1, wherein the inserting comprises inserting two file-attachment interface elements, a first of the file-attachment interface elements for attaching documents already stored at the online storage system, and a second of the file-attachment interface elements for attaching local documents via upload to the online storage system rather than to the electronic mail system.

4. The method of claim 1, wherein the adding comprises:
presenting, in response to selection of the file-attachment interface element, a user interface for document selection;
initiating, in response to selection of one or more documents, document upload from local storage to the online storage system as a background process;
obtaining the link information before the document upload completes; and
inserting the link information into the electronic mail message.

5. The method of claim 4, comprising sending access control information for the one or more documents to the online storage system, and wherein the obtaining the link information comprises obtaining a link to an attachment package at the online storage system having the access control information associated with the attachment package.

6. The method of claim 4, wherein the obtaining the link information comprises obtaining multiple links to an attachment package at the online storage system, and the inserting the link information comprises inserting a unique link to the attachment package for each of a plurality of designated recipients of the electronic mail message.

7. A computer program product, encoded on a computer-readable medium, operable to cause data processing apparatus to perform operations comprising:
receiving information designating an electronic mail message currently being generated for an electronic mail system residing in a first domain of a computer internetwork;
inserting, in response to the receiving, a file-attachment interface element into a user interface for the electronic mail message; and
adding, in response to use of the file-attachment interface element, to the electronic mail message link information identifying a document stored in an online storage system residing in a second domain of the computer internetwork.

8. The computer program product of claim 7, wherein the receiving comprises receiving, in a Web browser plug-in, markup language information defining the electronic mail message currently being generated for the electronic mail system comprising a Web based electronic mail system, and the inserting comprises inserting into the markup language information the file-attachment interface element in accordance with a link format of the Web based electronic mail system.

9. The computer program product of claim 7, wherein the inserting comprises inserting two file-attachment interface elements, a first of the file-attachment interface elements for attaching documents already stored at the online storage system, and a second of the file-attachment interface elements for attaching local documents via upload to the online storage system rather than to the electronic mail system.

10. The computer program product of claim 7, wherein the adding comprises:
presenting, in response to selection of the file-attachment interface element, a user interface for document selection;
initiating, in response to selection of one or more documents, document upload from local storage to the online storage system as a background process;
obtaining the link information before the document upload completes; and
inserting the link information into the electronic mail message.

11. The computer program product of claim 10, the operations comprising sending access control information for the one or more documents to the online storage system, and wherein the obtaining the link information comprises obtaining a link to an attachment package at the online storage system having the access control information associated with the attachment package.

12. The computer program product of claim 10, wherein the obtaining the link information comprises obtaining multiple links to an attachment package at the online storage system, and the inserting the link information comprises inserting a unique link to the attachment package for each of a plurality of designated recipients of the electronic mail message.

13. A system comprising:
an online storage system; and
a computer-readable medium having encoded thereon a computer program structured to interact with an electronic mail system and to provide a file-attachment interface that uploads a document to the online storage system in a separate process, and adds associated link information to an electronic mail message before completion of the separate process, in response to requested attachment of the document to the electronic mail message.

14. The system of claim 13, wherein the online storage system resides in a first domain of a computer internetwork, the electronic mail system resides in a second domain of the computer internetwork, and the computer program resides in a third domain of the computer internetwork.

15. The system of claim 14, wherein the electronic mail system comprises a Web based electronic mail system, and the computer program comprises a Web browser plug-in structured to insert a file-attachment interface element into a Web page in accordance with a link format of the Web based electronic mail system.

16. The system of claim 14, wherein the file-attachment interface comprises a first file-attachment interface element for attaching documents already stored at the online storage system, and a second file-attachment interface element for attaching local documents via upload to the online storage system.

17. The system of claim 14, wherein the online storage system is structured to provide the link information to the computer program before completion of the separate process.

18. The system of claim 17, wherein the separate process comprises an upload application for the online storage system.

19. The system of claim 17, wherein the online storage system comprises an access control component structured to restrict access to the document based on user provided access control information.

20. The system of claim 17, wherein the online storage system is structured to provide the link information comprising multiple links to the document, the multiple links comprising a unique link to the document for each of a plurality of designated recipients of the electronic mail message.
